(19) United States
(12) Patent Application Publication
(10) Pub. No.: US 2026/0338581 A1
(43) Pub. Date: Oct. 29, 2026

(54) VEHICLE CONTROL APPARATUS AND A METHOD THEREOF

(71) Applicants: HYUNDAI MOTOR COMPANY, Seoul (KR); KIA CORPORATION, Seoul (KR)

(72) Inventor: Cho Rong Ryu, Hwaseong-si (KR)

(73) Assignees: HYUNDAI MOTOR COMPANY, Seoul (KR); KIA CORPORATION, Seoul (KR)

(21) Appl. No.: 19/396,992

(22) Filed: Nov. 21, 2025

(30) Foreign Application Priority Data
Apr. 29, 2025 (KR) 10-2025-0056539

(51) Int. Cl. G01C 21/00; G01S 17/89; G01S 17/931

(52) U.S. Cl. CPC G01C 21/3859; G01C 21/3819; G01S 17/89; G01S 17/931

(57) ABSTRACT

A vehicle control apparatus includes a first processor that generates valid sensor data based on raw data collected from at least one sensor, a management device that loads and manages high-definition (HD) map data, and a second processor. The second processor filters data for map matching from the valid sensor data, selects data whose reliability satisfies a predefined threshold from the filtered valid sensor data, determines an offset by comparing the selected data with the HD map data, corrects the selected data based on the determined offset, determines a position of a vehicle by matching the corrected data with the HD map data, and controls the vehicle based on the determined position of the vehicle.

### CROSS-REFERENCE TO RELATED APPLICATION

This application claims priority to Korean Patent Application No. 10-2025-0056539, filed in the Korean Intellectual Property Office on Apr. 29, 2025, the entire contents of which are incorporated herein by reference.

### TECHNICAL FIELD

The present disclosure relates to a vehicle control apparatus and a method thereof, and more particularly, relates to technologies for supporting a high-definition map service based on an autonomous driving technology.

### BACKGROUND

An intelligent transportation system (ITS) is an integrated traffic system for optimizing an interaction between a traffic infrastructure, a vehicle, a road, and a user using advanced information and communication technology (ICT) to improve safety, efficiency, and convenience. Recently, with the development of wireless communication system, as an example, services for a smart city and a smart car have been more embodied based on third generation (3G), fourth generation (4G), and fifth generation (5G) communication technologies and an Internet of things (IoT)-related technology. Particularly, high-speed communication, low latency and bulk data transfer are supported using 5G-Adv, 6G, and next-generation communication technologies and IoT security, edge computing/network slicing, energy efficiency, low power wide area (LPWA) communication, and the like and discuss about a communication technology between a vehicle and an external entity, such as another vehicle or an infrastructure, is embodied.

A vehicle includes a communication control unit (CCU) for exchanging or sharing communication information with the outside. The vehicle has been developed in a method for more efficiently predicting a collision accident and a road situation while transmitting and receiving mutual driving information while communicating with the vehicle in real time via the CCU. As an example, vehicle to everything (V2X) is a communication scheme for exchanging or sharing information, such as a traffic situation, while communicating with a road infrastructure and another vehicle while driving, which has been developed to a technology in which all elements of the road (e.g., a vehicle and a vehicle, a vehicle and an infrastructure, a vehicle and a pedestrian, a vehicle and a network, and the like) transmit and receive information in real time.

Furthermore, a navigation technology has been continuously developed via introduction of various technologies, integration with autonomous driving, and the like and has been advanced to a synthetic driving support system over simple route guidance. Such a navigation technology increases convenience and safety of a vehicle at the same time and is becoming a key element of smart mobility.

### SUMMARY

The present disclosure has been made to solve the above-mentioned problems occurring in the prior art while advantages achieved by the prior art are maintained.

An aspect of the present disclosure provides a vehicle control apparatus for supporting a high-definition map service and a method thereof.

Another aspect of the present disclosure provides a vehicle control apparatus for performing map matching with regard to high-definition map data and a method thereof.

Another aspect of the present disclosure provides a vehicle control apparatus for predicting a road edge and performing map matching and a method thereof.

Another aspect of the present disclosure provides a vehicle control apparatus for performing map matching with regard to sensor data and a method thereof.

Another aspect of the present disclosure provides a vehicle control apparatus for estimating an offset of a road edge to check a position of a vehicle and a method thereof.

The technical problems to be solved by the present disclosure are not limited to the aforementioned problems, and any other technical problems not mentioned herein should be clearly understood from the following description by one having ordinary skill in the art to which the present disclosure pertains.

According to an aspect of the present disclosure, a vehicle control apparatus may include a first processor that generates valid sensor data based on raw data collected from at least one sensor, a management device that loads and manages high-definition (HD) map data, and a second processor. The second processor filters data for map matching from the valid sensor data, selects data whose reliability satisfies a predefined threshold from the filtered valid sensor data, determines an offset by comparing the selected data with the HD map data, corrects the selected data based on the determined offset, determines a position of a vehicle by matching the corrected data with the HD map data, and controls the vehicle based on the determined position of the vehicle.

In an embodiment of the present disclosure, the second processor may include a map matching module. The map matching module may manage the offset in the form of a list or a stack including identification information about each object. The offset may be calculated by applying a moving average. The identification information may be assigned to each object in response to a map segment of an HD map.

In an embodiment of the present disclosure, the map matching module may include a data filtering device that selectively filters line or point data associated with a road edge from the valid sensor data and store and manage the filtered data.

In an embodiment of the present disclosure, the data filtering device may remove sensor data which does not meet a condition of at least one of a distance, an angle, or a height from the valid sensor data.

In an embodiment of the present disclosure, the map matching module may include a data selection device that extracts data most suitable for matching from the valid sensor data.

In an embodiment of the present disclosure, the map matching module may include an offset estimation device that checks an offset generated on road edge coordinates between the selected data and the HD map data.

In an embodiment of the present disclosure, the offset estimation device may estimate an offset for each map segment and calculate the offset by checking a map segment closest to a sensor segment.

In an embodiment of the present disclosure, the offset estimation device may calculate an average value for the offset of the sensor segment for each map segment and store the calculated average value.

In an embodiment of the present disclosure, the offset estimation device may perform a correction by applying an amount of lateral correction of a lane to road edge sensor recognition data.

In an embodiment of the present disclosure, the map matching module may include an offset estimation device that stores the offset for each identification information in response to the map segment of the HD map, stores the offset based on a current position, updates the offset based on a current frame, or deletes invalid data.

In an embodiment of the present disclosure, the map matching module may include a map matching device that applies a matching algorithm to the data of the sensor and the HD map data to calculate an amount of position correction. The map matching device may estimate a position and a pose by applying an algorithm for matching two points.

In an embodiment of the present disclosure, the map matching device may calculate an amount of correction for a lateral position and a heading position for the selected data and calculate and output a position of the vehicle in an absolute coordinate system to which the amount of correction is applied.

In an embodiment of the present disclosure, the map matching module calculate a may position change, using information about translation on a coordinate system of the vehicle and information of a rotation angle, the offset includes a lateral correction value including at least one of a forward lane or a side lane, and generate road edge sensor data by applying time compensation to the lateral correction.

In an embodiment of the present disclosure, the map matching module may include a map matching device that applies a matching algorithm to the data of the sensor and the HD map data to calculate an amount of position correction. The map matching device may estimate a position and a pose by applying an algorithm for matching two points.

In an embodiment of the present disclosure, the map matching module may apply rotation correction such that the offset becomes minimum by comparing a translation distance of the vehicle, the translation distance being checked via a global coordinate system, with a translation distance checked via the sensor.

In an embodiment of the present disclosure, the map matching module may calculate a distance with the map segment for each sensor segment, calculate an average offset with regard to a relative offset for each map segment, and estimate a lateral position and a heading position of the vehicle based on the calculated average offset.

In an embodiment of the present disclosure, the first processor may generate the raw data as the data for the map matching by checking the raw data and removing or correcting noise.

In an embodiment of the present disclosure, the management device may parse an HD map including road edge information and extract edge information of a top line or a bottom line of a road as two-dimensional segment information from the parsed HD map. The road edge information may include road geometry information or road facility information.

In an embodiment of the present disclosure, the at least one sensor may include light and detection ranging (LiDAR) sensor. The second processor may check contour data of each object recognized using the LiDAR sensor, may check a size, a shape, a position of each object using the contour data, and may maintain and manage data of each object by classifying the contour data as a layer number. The contour data may include points cloud data indicating a contour of the object.

According to another aspect of the present disclosure, a vehicle control method may include filtering data for map matching from raw data, loading and managing high-definition (HD) map data, filtering data for map matching from the valid sensor data, selecting data whose reliability satisfies a predefined threshold from the filtered data, determining an offset by comparing the selected data with the HD map data, correcting the selected data based on the determined offset, determining a position of a vehicle by matching the corrected data with the HD map data, and controlling the vehicle based on the determined the position of the vehicle. The matching may include comparing a translation distance of the vehicle, the translation distance determined in a global coordinate system, with a translation distance of the selected data and applying rotation correction based on the comparison to minimize the offset, thereby performing matching. The offset may be calculated by applying a moving average and may be managed in the form of a list or a stack including identification information about each object.

### BRIEF DESCRIPTION OF THE DRAWINGS

The above and other objects, features and advantages of the present disclosure should be more apparent from the following detailed description taken in conjunction with the accompanying drawings.

FIG. 1 is a block diagram illustrating a configuration of a vehicle system including a vehicle control apparatus according to an embodiment of the present disclosure.

FIG. 2 is a drawing schematically illustrating a configuration diagram of a vehicle communication control system for efficiently controlling a wireless network connection to reduce power consumption according to an example of the present disclosure.

FIG. 3 is a conceptual diagram schematically illustrating the concept of performing road edge map matching according to an embodiment of the present disclosure.

FIG. 4 is a block diagram of a vehicle control apparatus for estimating an offset and performing road edge map matching according to an embodiment of the present disclosure.

FIGS. 5A and 5B are drawings illustrating the concept of estimating a road edge offset and the concept of managing an offset according to an embodiment of the present disclosure.

FIG. 6 is a drawing illustrating the concept of correcting road edge data according to an embodiment of the present disclosure.

FIGS. 7A and 7B are drawings illustrating the concept of calculating an offset of a map segment according to an embodiment of the present disclosure.

FIGS. 8A, 8B, and 8C are drawings illustrating the concept of updating a road edge offset according to an embodiment of the present disclosure.

FIG. 9 is a drawing illustrating an example of applying a road edge offset to implement a map according to an embodiment of the present disclosure.

FIG. 10 illustrates a computing system according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical component is designated by the identical numerals even when they are displayed on other drawings. Further, in describing an embodiment of the present disclosure, a detailed description of well-known features or functions has been omitted in order not to unnecessarily obscure the gist of the present disclosure.

In describing components of embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being understood by those having ordinary skill in the art to which the present disclosure pertains. Such terms as those defined in a dictionary are to be interpreted as having meanings equal to the contextual meanings in the relevant field of art, and are not to be interpreted as having ideal or excessively formal meanings unless clearly defined as having such in the present application. When a component, unit, controller, module, device, element, apparatus, or the like of the present disclosure is described as having a purpose or performing an operation, function, or the like, the component, unit, controller, module, device, element, apparatus, or the like should be considered herein as being “configured to” meet that purpose or to perform that operation or function. Each component, unit, controller, module, device, element, apparatus, and the like may separately embody or be included with a processor and a memory, such as a non-transitory computer readable media, as part of the apparatus.

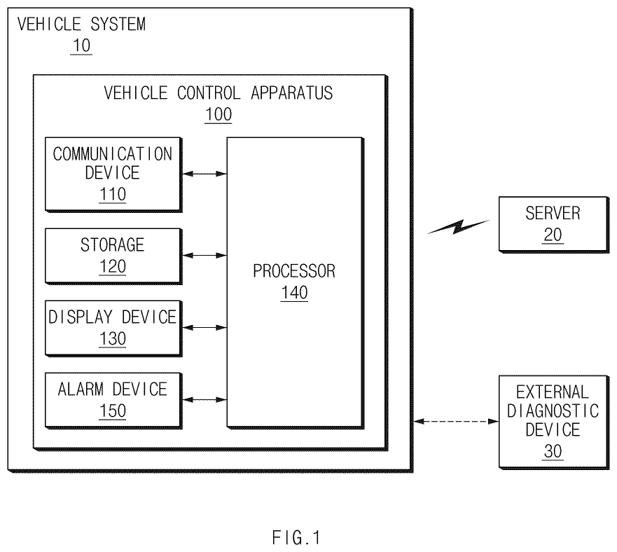

Hereinafter, embodiments of the present disclosure are described in detail with reference to FIGS. 1-10.

FIG. 1 is a block diagram illustrating a configuration of a vehicle system including a vehicle control apparatus according to an embodiment of the present disclosure.

Referring to FIG. 1, a vehicle control apparatus 100 according to an embodiment of the present disclosure may be implemented in a vehicle. In this case, the vehicle control apparatus 100 may be integrally configured with control units in the vehicle or may be implemented as a separate device to be connected with the control units of the vehicle by a separate connection means. As an example, the vehicle control apparatus 100 may include a shift control device for managing and controlling various sub-systems (e.g., a shift device, an engine, a brake, and the like) of the vehicle in an integrated manner. Furthermore, the vehicle control apparatus 100 may include a program for supporting a navigation service and guiding a route to a destination based on a current location of the vehicle. Furthermore, the vehicle control apparatus 100 may include an infotainment platform and system for providing an accurate route using a global positioning system (GPS) and map data and reflecting real-time traffic information to provide an optimal route. In addition, the vehicle control apparatus 100 according to an embodiment of the present disclosure may include a global navigation satellite system (GNSS) antenna and may receive various global GNSS signals. The vehicle control apparatus 100 may be integrally configured with a plurality of control units or may be implemented as a separate device to be connected with the control units of the vehicle.

The vehicle control apparatus 100 according to an embodiment of the present disclosure may include a communication device 110, storage 120, a display device 130, a processor 140, and an alarm device 150.

The communication device 110 may be a hardware device implemented with various electronic circuits to transmit and receive a signal via a wireless or wired connection, which may perform in-vehicle communication via controller area network (CAN) communication, CAN flexible data rate (CAN-FD) communication, local interconnect network (LIN) communication, Ethernet communication, or the like according to an embodiment of the present disclosure and may include various communication units, for example, a mobile communication unit, a broadcast reception unit, such as a digital multimedia broadcasting (DMB) module or a digital video broadcasting-handheld (DVB-H) module, a short range communication unit, such as a ZigBee module, which is a Bluetooth module, or a near field communication (NFC) module, and a wireless-fidelity (Wi-Fi) communication unit, for communication with a server 20, external diagnostic device (or external tester) 30, and the like, which are outside the vehicle. The CAN communication is a network system for vehicle, which is developed to provide digital serial communication between various pieces of measurement control equipment in the vehicle. A CAN-data bus is used for data transfer and control between electronic control units (ECUs). Furthermore, the communication device 110 according of the present disclosure may perform to an embodiment communication bidirectionally between a vehicle and a surrounding vehicle, a vehicle and a road infrastructure, and a vehicle and a pedestrian and may continuously share and transmit and receive data with all elements including a host vehicle and a surrounding vehicle. Particularly, the communication device 110 according to an embodiment of the present disclosure may perform communication which is linked to a fifth generation (5G), sixth generation (6G), or vehicle-to-everything (V2X) communication technology to operate a real-time vehicle operation system.

The communication device 110 may be configured in the form of being internally loaded into the vehicle or being in contact with a communication terminal. As a result, the communication device 110 may perform vehicle-to-vehicle communication and vehicle-to-infrastructure communication and may perform autonomous driving to a determined destination via a vehicle sensor and a driving control function provided in the vehicle. As described above, the vehicle sensor according to an embodiment of the present disclosure may include at least one of a gyro sensor or an acceleration sensor as well as a global navigation satellite system (GNSS) sensor and a global positioning system (GPS) sensor. The GNSS sensor, the GPS sensor, the gyro sensor, the acceleration sensor, a barometer, or the like may measure location, motion, pose, or movement direction information or the like of the vehicle and may be coupled to other sensors in the vehicle to support driving safety, autonomous driving, navigation, and vehicle tracking and management. Particularly, the GNSS sensor according to an embodiment of the present disclosure may fuse with various communication sensors, such as automatic dependent surveillance-broadcast (ADS-B), light and detection and ranging (LiDAR), radio and detection and ranging (RADAR), a V2X module, and a 5G/6G modem, to operate. Particularly, the gyro sensor and the acceleration sensor may be coupled to the LiDAR, a camera, or the RADAR to monitor a location and a pose of the vehicle in real time. The acceleration sensor and the gyro sensor may be combined with each other to control rotation and acceleration of the vehicle. Furthermore, the location may be tracked via the GNSS sensor and the GPS sensor, the direction may be maintained using the gyro sensor, and the change in motion may be detected using the acceleration sensor to perform precise route tracking and real-time driving control for an autonomous vehicle and a precise positioning vehicle.

The communication device 110 may support a WAVE communication technology for a V2X communication function or may support a next-generation communication technology including 3GPP-based LTE/NR/5G-Adv and 6G. For example, when supporting a new radio (NR) access technology of a 5G system, the communication device 110 may support enhanced mobile broadband (eMBB), massive machine type communications (mMTC), or ultra-reliable and low-latency communications (URLLC). The communication device 110 may support a high-frequency band (e.g., mmWave band) to achieve a high data transfer rate. Various technologies applied to ensure performance in a high-frequency band by the communication device 110 may support, for example, beamforming, massive multiple-input and multiple-output (MIMO), full dimensional MIMO (FD-MIMO), an array antenna, analog beam-forming, a large scale antenna, or the like. Furthermore, as a next-generation communication technology is developed, a new type of AL/ML module or the like which is newly proposed may be used. A wireless communication module capable of performing a signal processing task, such as channel estimation, equalization, or demapping, may be supported. Thus, service optimization and data via a more efficient network air interface, channel estimation, or the like may be applied.

As an example according to the present disclosure, when supporting wireless access for vehicle environment (WAVE) communication, the communication device 110 may support an IEEE 802.11a wireless LAN technology for smooth V2V and V2I communication. Thus, the communication device 110 may use a 10 MHz channel bandwidth in a 5.9 GHz band, may support a maximum of 27 Mbps data rate, may support CSMA/CA in a wireless channel access scheme, and may support that a physical layer is based on IEEE 802.11p and an upper layer uses IEEE 1609.x standard. Furthermore, when supporting the 3GPP system, the communication device 110 according to an embodiment of the present disclosure may support LTE eV2X, 5G/5G-Adv, and 6G NR V2X communication technologies, based on LTE V2X (Rel. 14). V2X communication includes vehicle-to-vehicle (V2V) referring to LTE/NR-based communication between vehicles, vehicle-to-pedestrian (V2P) referring to LTE/NR-based communication between terminals carried by a vehicle and a person, and vehicle-to-infrastructure/network (V2I/N) referring to LTE/NR-based communication between a vehicle and a roadside unit/network and has a characteristic in which network scalability is improved in V2I communication using OFDMA wireless access. In addition, 5G NR, 5G-Adv, 6G, and next-generation communication systems may support a more improved V2X service, such as sensor data sharing of an autonomous vehicle for ultra-low latency and high reliability communication and a high-definition map update. Thus, the communication device 110 may improve reliability, latency, a throughput, or the like of vehicle communication to support a safer and more efficient traffic system.

The storage 120 may download and store various pieces of service data for a corresponding vehicle and data for a vehicle wireless update, which are received from the server 20 via the communication device 110. Thus, the storage 120 may store GNSS location information, sensor data, network state information, and the like via vehicle sensors provided in the vehicle and the server 20. Furthermore, according to the present disclosure, the storage 120 may store/manage data for various input sensors for supporting autonomous driving and may store/manage data via a server for supporting road information, communication information, and the like. This includes that it is able to store/manage/update road and traffic information received via a communication server and pieces of data input via various sensors provided inside/outside the vehicle.

The storage 120 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The display device 130 may be controlled by the processor 140 to display a screen for receiving approval for user authentication for a wireless update of the vehicle. The display device 130 may be implemented as a head-up display (HUD), a cluster, audio video navigation (AVN), audio, video, navigation & telematics (AVNT), or the like. Furthermore, the display device 130 may include at least one of a liquid crystal display (LCD), a thin film transistor-LCD (TFT-LCD), a light emitting diode (LED) display, an organic LED (OLED) display, an active matrix OLED (AMOLED) display, a flexible display, a bended display, or a three-dimensional (3D) display. Some thereof may be implemented as transparent displays configured as a transparent type or a semi-transparent type to see the outside. Furthermore, the display device 130 may be provided as a touchscreen including a touch panel to be used as an input device other than an output device.

The vehicle control apparatus 100 according to an embodiment of the present disclosure may implement an infotainment system via the communication device 110, the storage 120, the display device 130, the processor 140, and the alarm device 150. Particularly, the vehicle control apparatus 100 may support a real-time navigation system via the communication device 110 and the storage 120 and may download vehicle data to adaptively implement navigation software (SW) if necessary. Furthermore, the vehicle control apparatus 100 may visualize and provide a corresponding route to a user in real time with regard to driving information updated in real time or the like via the display device 130, for example, at least one of display devices including AVNT, a cluster, a head-up display (HUD), and a multi-function display (MFD). The sensor and the units are selectively described for ease of description, but the sensor and the units may be included in the form of being added or changed and combined for the expanded concept of the present disclosure. This may include implementing a sensor for another infotainment system and another navigation system in the form of being added or changed, depending on service environments of a user and a driver.

A description is given in detail below of the display device 130 according to an embodiment of the present disclosure. The AVNT may interwork with advanced driver assistance systems (ADAS) to support driving of the driver using various sensors and various pieces of software loaded into the vehicle and may provide a notification of a driving assistance system, such as lane keeping, a collision warning, or a vehicle control state.

The cluster of the vehicle switches based on a digital display, supports high-definition graphics, changes in design to suit various driving modes to provide user service improvement. The HUD may include a device for projecting driving-related information onto a front glass or a dedicated display of the vehicle to help the driver to check necessary information while keeping his or her eyes on the road. The HUD may project a current speed, a speed limit, and a navigation route onto the front of the field of view of the driver in conjunction with speed and route guidance and may support a collision warning, a lane keeping state, a safety distance, or the like in conjunction with ADAS information.

Furthermore, the HUD may apply an AR technology to overlay a route and a direction arrow with a road ahead and may display a traffic signal, a location of a surrounding vehicle, a road risk element, or the like. Such a HUD is able to allow the driver to check driving information without taking his or her eyes off the road. Thus, an AR-based HUD function may be expanded and applied in a high-end vehicle model. Furthermore, the HUD may directly project flight data onto a field of view of the driver (or a pilot) to provide immediate information or may be used as an obstacle detection and landing assistance system in an autonomous flight mode via an augmented reality (AR) HUD system.

The processor 140 may be electrically connected with the communication device 110, the storage 120, the display device 130, the alarm device 150, or the like and may electrically control the respective components. The processor 140 may be an electrical circuit which executes instructions of software and may perform a variety of data processing and calculation described below. Such a processor 140 may apply a new type of active learning/machine learning (AL/ML) model newly proposed or may support adaptive data processing and calculation with regard to an AL/ML model implemented therein.

When a screen for receiving approval from the user is displayed on the display device 130, the alarm device 150 may output a notification for approval to the user. Alternatively, the alarm device 150 may provide V2X information about a route resetting for a congestion degree, driving guidance, such as an alarm for a congestion degree, traffic safety, and the like and pieces of infotainment information in the vehicle. Furthermore, the alarm device 150 according to an embodiment of the present disclosure may visually provide a service for more precisely warning via an AR navigation map view based on a camera image via an AR integrated technology. Furthermore, the alarm device 150 may provide a notification operation to adaptively perform a control operation in response to a risk situation via each unit in the vehicle and the display device 130.

The processor 140 according to an embodiment of the present disclosure may apply various route calculation algorithms to provide an algorithm for a shortest route or an optimal route. As an example, a Dijkstra's algorithm, an A star (A*) algorithm, ant colony optimization (ACO), a rapidly-exploring random tree (RRT), deep reinforcement learning (DRL), or the like is applicable to the route calculation algorithm to which the present disclosure is applicable. A transformation algorithm in a complex form or in the form of being selectively combined with regard to advantages/disadvantages of the respective algorithms is applicable to the route calculation algorithm to which the present disclosure is applicable. In addition, the vehicle control apparatus 100 including a navigation system of the present disclosure for supporting AL/ML is able to perform optimal route planning considering collision prevention, weather avoidance, battery efficiency, or the like, rather than the simple shortest route, via an artificial intelligence/machine learning (AI/ML) algorithm.

Furthermore, the processor 140 according to an embodiment of the present disclosure may control the display device 130 to display the calculated optimal route on the navigation system to which augmented reality (AR) is applied. As an example, the processor 140 may visualize and provide a GNSS and Ai-based optimal route as a 3D map. The processor 140 may guide an integrated route together with a route guidance guideline, a visual indication on a flight route, an altitude, and speed information via a head-up display (HUD) and an AR-based display. Furthermore, the vehicle control apparatus 100 may learn data in real time to provide an optimal route via an AI/ML function. AR may control to visually represent it and may particularly control to integrate various data sources to integrate a GPS, a traffic volume, V2X, and weather data and provide sophisticated driving information.

The vehicle according to the present disclosure may include a plurality of electronic control units (ECUs), which may be connected with internal/external communication to provide an increase in safety of the user and various convenience functions. The ECU may be a module for performing various electronic control functions in the vehicle. As an example, the ECU may include an engine control module (ECM) for taking charge of engine performance optimization and control, a transmission control module (TCM) for taking charge of management of a shift device, a brake module (BCM) for managing and controlling a brake system, an airbag control unit (ACU) for controlling operation and management of an airbag, a body control module (BCM) for managing and controlling a vehicle body-related function, such as door lock or an ambient light of the vehicle, and the like.

Particularly, the ECU may include a flight control unit (FCU) to adjust a flight route based on sensor data of a sensor (e.g., a GNSS, an IMU, LiDAR, RADAR, or the like) and support automatic flight and manual piloting. In this regard, a controller area network (CAN) data bus may support communication between ECUs in the vehicle. As a result, ECUs may transmit and receive sensor data and a command in real time and may control various functions of the vehicle in an integrated manner. Alternatively, FlexRay may be applied to a communication protocol for vehicle. The FlexRay may support a maximum of 10 Mbps data transfer rate and may implement redundancy via two independent communication channels or may increase data transfer.

Furthermore, the FlexRay may apply the concept of a time slot such that all nodes on the network are able to transmit data without collision using a TDMA scheme and may share data necessary to determine autonomous driving between ECUs to support ADAS and autonomous driving. As an example, data generated in the vehicle via the FlexRay may be transmitted to another vehicle or an infrastructure over a 3GPP-based communication network. High-speed data transfer and communication with a network may be performed via Ethernet time-sensitive networking (TSN) and a data distribution service (DDS).

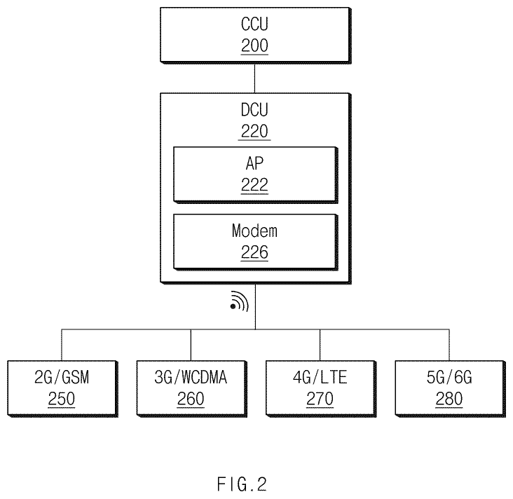

FIG. 2 is a drawing schematically illustrating a configuration diagram of a vehicle communication control system for efficiently controlling a wireless network connection to reduce power consumption according to an example of the present disclosure.

Referring to FIG. 2, a communication control unit (CCU) 200 may be a communication control device of a vehicle, which may include a central control device for managing data communication between networks inside and output the vehicle. Furthermore, the CCU 200 may include providing a connection between various ECUs and systems in the vehicle and with an external server or a cloud service. The CCU 200 according to an example of the present disclosure may support V2X communication (e.g., vehicle-to-vehicle (V2V) and vehicle-to-infrastructure (V2I) data exchange) and may support a connected service (e.g., real-time navigation, remote diagnosis, or an over-the-air (OTA) update).

A domain communication unit (DCU) 220 may be a control device for controlling and managing a specific domain (or a function area) of the vehicle, which may integrate a plurality of distributed ECUs to efficiently control each domain. As an example, the DCU 220 may analyze data of LiDAR/RADAR and may deliver the analyzed data to an FCU (not shown) and the CCU 200 or the DCU 220 may report a battery state to the CCU 200 to request power distribution optimization. Alternatively, when an accident occurs, the CCU 200 may control to transmit a landing command to the DCU 220.

The DCU 220 may be connected with a 5G/6G network 280 via a corresponding modem 226 to perform ultra-reliable low latency communications (URLLC) via an access point (AP) 222, perform mmWave 5G communication, or support a 6G ultra-reliable low latency network service. Furthermore, when data is processed in real time with regard to a service characteristic of the AP 222, the DCU 220 may support quick and accurate data processing. As a result, the DCU 220 may reinforce autonomous vehicle and a vehicle control function. This may include a state in which a connections setup is maintained in a next-generation communication wireless network system including GSM 250, WCDMA 260, LTE 270, and NR/5G-Adv/6G 280 depending on a surrounding network environment. Furthermore, the DCU 220 may render and display navigation map data at high definition on a display. The DCU 220 may control to display a navigation route on a dashboard cluster and a HUD to control a multimodal display or may support an AR navigation function. Thus, the CCU 200 may visually overlay a route based on camera data to support an improved AR map view.

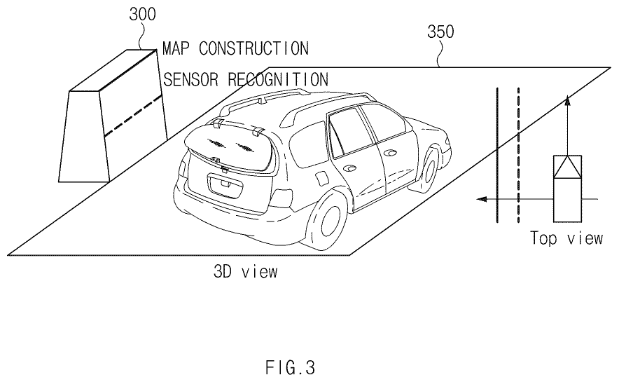

FIG. 3 is a conceptual diagram schematically illustrating the concept of a vehicle control apparatus for performing road edge map matching according to an embodiment of the present disclosure.

Referring to FIG. 3, a vehicle control apparatus 300 may recognize a surrounding environment in real time via various sensors (e.g., LiDAR, RADAR, a camera, a GPS/IMU, and the like). There may be a case in which it is difficult to identify a position of a vehicle due to noise or an environmental factor using sensor data. To this end, the vehicle control apparatus 300 according to an embodiment of the present disclosure may more accurately estimate the position of the vehicle and a pose (e.g., a lateral position, a heading position, or the like) of the vehicle using a high-definition (HD) map 350. The HD map 350 may include information in which various elements, such as geometry of roads, lines of the roads, road edges, signs, and traffic lights, are recorded in advance at higher resolution than a general map.

As a result, the HD map 350 may assist in reducing an error included in the sensor data and particularly correcting a position of the vehicle in a situation in which a GPS signal is unstable (e.g., a tunnel or an urban dense area). As an example, the vehicle control apparatus 300 may extract a feature (e.g., a line, an edge, or the like) of a road via real-time sensor data obtained via LiDAR or a camera, may compare the extracted feature with information of the HD map, and may minimize an error to estimate a lateral position of the vehicle (or a left and right position compared to the center of the road) and a heading position (or a driving direction). As described above, an autonomous driving system may estimate the lateral position and the heading position of the vehicle using a map matching algorithm for receiving and matching the HD map with a sensor value. Furthermore, the autonomous driving system may generate a route based on the estimated position of the vehicle and may control the vehicle to suit the generated route to support an autonomous driving service. Matching the road edge recognized by the sensor and a previously constructed HD map road edge to estimate a position of the vehicle is referred to as road edge map matching.

The HD map may divide a road edge into a top line or a bottom line to be output in the form of a 2D segment (including a height value z) with construction height value (z) information based on original drawing specifications (e.g., referring to an original design drawing (or an original drawing) of the road, which is criteria for constituting edge information of the road or specifications according to it and including reference data indicating how a shape, a line, an edge, or the like of a real road is designed when constructing the road).

When there is a bush or another obstacle in front of a road edge structure, the sensor may continuously recognize a corresponding position as a place different from an HD map position. Furthermore, when a map construction height and a sensor recognition height are different from each other in a road edge where a lateral distance varies with height, there may be a sensor recognition result in a place different from the HD map. As an example shown in FIG. 3, when map construction and sensor recognition are different from each other and when such a sensor recognition result is used for map matching, a lateral or heading error may occur.

Thus, the vehicle control apparatus 300 according to an embodiment of the present disclosure may supplement the limit of the sensor data to support an efficient autonomous driving method which is safer and has ensured reliability. To this end, the vehicle control apparatus 300 may include estimating and managing an offset between a sensor and a map for each segment of the HD map and ensuring reliability of road edge map matching performance using it.

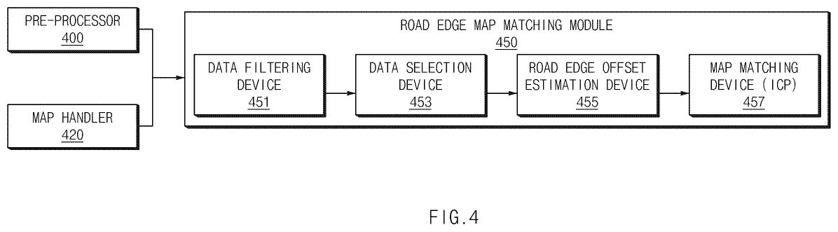

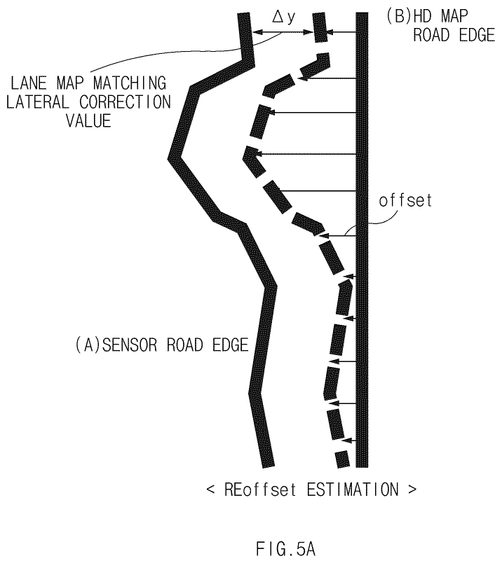

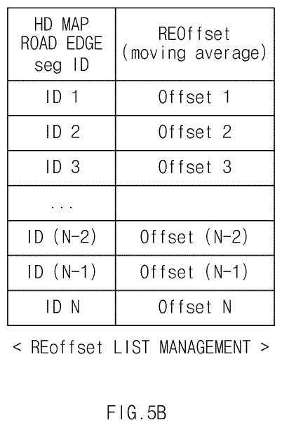

FIG. 4 is a block diagram of a vehicle control apparatus for estimating an offset and performing road edge map matching according to an embodiment of the present disclosure. FIGS. 5A and 5B are drawings illustrating the concept of estimating a road edge offset and the concept of managing an offset according to an embodiment of the present disclosure.

Referring to FIG. 4, the vehicle control apparatus according to an embodiment of the present disclosure may assist a vehicle to accurately recognize an edge of a road (e.g., a top line/bottom line of the road) and correct its position in an autonomous driving system. Particularly, the vehicle control apparatus may obtain sensor data from a plurality of sensors provided therein, may calculate an offset value for the sensor data, and may optimize alignment between the sensor data and map data.

A pre-processor 400 may include a processor for checking and processing raw data collected by the plurality of sensors implemented in the vehicle control apparatus. As an example, the pre-processor 400 may check contour data of each object recognized by a LiDAR sensor. Sensor data may include classifying and inputting all objects into layer numbers in the form of data. Furthermore, the contour data of each object recognized by the LiDAR sensor may include points cloud data indicating a contour of the object. Thus, the pre-processor 400 may identify a size, a shape, a position, or the like of each object using the contour data and may classify it as a layer number to manage data of each object.

Furthermore, the pre-processor 400 may generate the raw data as data for map matching via a process, such as noise cancellation, outlier correction, or data smoothing. In detail, the LiDAR sensor may emit a laser pulse to measure a reflection time when the laser beam is reflected from a surrounding object to return and may calculate a distance to each object. The pre-processor 400 may generate 3D point cloud data in a 360° or specific angle range based on such distance data.

The pre-processor 400 may generate the raw data obtained from the LiDAR sensor as data suitable for being used in a subsequent processing module (e.g., map matching, object recognition, or the like). The LiDAR sensor may generate noise or an outlier (or spurious points) due to an environmental factor or the limit of the sensor itself. Thus, the pre-processor 400 may remove or correct the generated noise to generate data. Furthermore, the pre-processor 400 may perform a downsampling process for processing a points cloud with high resolution, which is generated by the LiDAR sensor, in real time. As a result, the pre-processor 400 may reduce a computation load and may improve a processing speed. Furthermore, the pre-processor 400 may also perform a synchronization process for a timestamp of each sensor to integrate pieces of data of several sensors. Thus, the pre-processor 400 may process a plurality of pieces of sensor data as real-time data, may perform sampling as data with quick computation processing, and may accurately and quickly generate and manage more pieces of sensor data.

A map handler 420 may load and manage HD map data. The map handler 420 may be a term according to an embodiment of the present disclosure, which may be interchangeably referred to as a management device for loading and managing HD map data or a processing device. The map management device 420 may perform an operation of parsing an HD map including information of a road edge and extracting and structuralizing edge information, such as a top line or a bottom line of the road, in the form of a 2D segment (including a height value z). Furthermore, the map management device 420 may check road geometry information, for example, the number of lanes, a width of the lane, a type of the lane (e.g., a general lane, a bus-only lane, or the like), a lane changeable section, a start and end of the lane, a relative position between lanes, and pieces of curvature information.

Furthermore, the map management device 420 may check road facility information and may provide the road facility information to more accurately recognize a road environment. As an example, the map management device 420 may check traffic signs associated with road regulation information, such as a speed limit, no parking, or a one-way street, warning signs associated with an indication of a section needing caution, such as a sharp curve, a steep slope, or the danger of falling rocks, and positions and pieces of state information of traffic lights associated with an arrow signal (or left-turn or right-turn only) and a pedestrian signal, may perform map matching between the sensor data collected in real time and the HD map, and may promote driving determination, such as signal recognition, lane keeping, or an intersection pass.

A road edge map matching module 450 according to an embodiment of the present disclosure may be configured to include a data filtering device 451, a data selection device 453, a road edge offset estimation device 455, and a map matching device 457. The road edge map matching module 450 may be implemented in the form of a unit independent of a first processor for performing pre-processing to be operable and may be referred to as a second processor depending on convenience. Each unit implemented in the second processor for performing the map matching is illustrated in an independent form according to an embodiment of the present disclosure. However, the unit is able to be implemented as one processor to be implemented in the form of being processed via logically separated processing. Thus, the unit may include being implemented in an independent form via at least one chip or one or more processors or in the form of one fused processor.

The data filtering device 451 may play a role in checking data associated with a road edge among the pre-processed pieces of sensor data and increasing consistency. As an example, the data filtering device 451 may select only map data which is present around the sensor or may select only sensor data which is around a height of map data. In other words, the data filtering device 451 may check data in which unnecessary data or noise is additionally removed among the pieces of sensor data and provide valid line or point data associated with an edge of the road.

The data filtering device 451 according to an embodiment of the present disclosure may perform an operation of removing unnecessary noise of the map and the sensor data or an error in the map and the sensor data and selectively storing/managing valid data for precise map matching. As an example, various pieces of segment data, such as a road edge, a line, and a sign may be included in an HD map. To match the various pieces of data with real-time sensor data, an unnecessary segment or noise of the map should be removed or correction according to necessity should be performed to perform efficient data management. Thus, the data filtering device 451 may filter and remove data (or a segment) which does not meet a distance condition or an angle condition on 2D among all sensor segments or may filter data (or a segment) which does not meet a distance condition, an angle condition, or a height condition on 2D for all map segments filtered by a plurality of sensors. Such a filtering operation may reduce an amount of computation unnecessary upon real-time map matching and may assist in performing more accurate localization and object recognition. This may provide the advantage of efficiently maintaining/managing data for a valid segment with regard to the distance condition and the angle condition.

The data selection device 453 may perform an operation of selecting data with high reliability or data with high accuracy among the pieces of data obtained from several sensors or the map. As an example, the data selection device 453 may select only one segment (or layer) of each object among the pieces of sensor data. The data selection device 453 may evaluate quality of each of the pieces of data and may extract data optimal for matching. This may include selecting optimal data for reducing an error in a subsequent processing step, when selecting data. As an example, the data selection device 453 may segment the map segment selected by the data filtering device 451 into a maximum of length of 10 m (actually, including setting the map segment in units for correcting a length, a size, or a value divided by a predetermined value for meeting a specific length or data quality, with regard to having a maximum of length of hundreds of meters in a straight road) and may select the closest map segment on 2D for each segment or may select one segment for each sensor object for each map segment.

The road edge offset estimation device 455 may correct a position difference between sensor data and map data. To this end, the road edge offset estimation device 455 may calculate a relative error (or offset) capable of occurring between sensor data and road edge coordinates on an HD map and may correct the sensor data based on the relative error to optimize alignment between the two pieces of data. The road edge offset estimation device 455 may estimate an offset for each map segment or may manage the offset in the form of a list and/or a stack.

As an example, the road edge offset estimation device 455 may apply an amount of lateral correction of a lane to road edge sensor recognition data to correct the amount of lateral correction of the lane. The road edge offset estimation device 455 may obtain the map segment closest to the sensor segment and may calculate an offset (or a distance apart or an error). This may be described with reference to FIG. 5A. The road edge offset estimation device 455 may obtain an average for an offset of a sensor matched for each map segment and may store the obtained offset. Furthermore, the road edge offset estimation device 455 may convert the stored REoffset stack value. The road edge offset estimation device 455 may manage an offset for each HD map segment ID in the form of that shown in FIG. 5B, may convert and manage an offset based on a current position, or may manage a reset or the like in the form of a list. The road edge offset estimation device 455 may include updating and managing an offset value calculated in a current frame in the stored REoffset stack. Furthermore, the road edge offset estimation device 455 may include deleting and managing invalid data among pieces of sensor segment data.

The map matching device 457 may control to match the corrected sensor data with HD map data such that the position of the vehicle is identical to the position of the road edge. The map matching device 457 may precisely estimate a lateral position and a heading position (or a driving direction) of the vehicle, using an optimization algorithm (e.g., a Kalman filter, a particle filter, or the like), and may update position information in real time.

A description is given below of an example in which the map matching device 457 according to an example of the present disclosure calculates an amount of position correction using a matching iterative closest point (ICP) algorithm between LiDAR data and the HD map. The ICP algorithm may be an algorithm for matching two points (or a point cloud) to estimate a position and a pose (or a degree of freedom), which may align a LiDAR point cloud and the HD map at fixed density. The map matching device 457 of the present disclosure may include applying normal distributions transform (NDT) for dividing a space into grids and modeling and matching point distribution in each cell as normal distribution and an algorithm considering a surface structure (e.g., a plane, an edge, or the like) as well as a position of each edge, which is a scheme for combining advantages of the CP and the NDT, to perform position correction. The algorithm is described as an example. The present disclosure may include that it is possible to apply other algorithms capable of performing efficient addition/expansion to map matching.

Thus, the map matching device 457 may calculate the map data segmented by the data selection device 453 and the selected sensor data as an amount of lateral/heading (local) correction via, for example, the ICP algorithm and may calculate and output a position (latitude-longitude-height, LLH) of an absolute vehicle coordinate system to which the amount of correction is applied. As described above, the road edge map matching module 450 may derive accurate matching between the position of the vehicle and the road edge, using the finally corrected data, thus supporting stable road driving of an autonomous driving system.

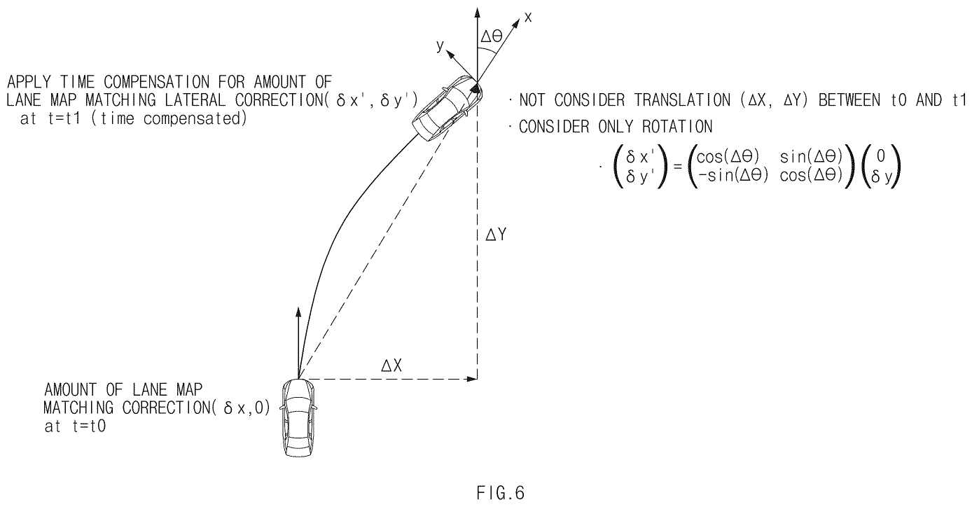

FIG. 6 is a drawing illustrating the concept of correcting road edge data according to an embodiment of the present disclosure.

Referring to FIG. 6, an operation of a road edge offset estimation device is described by estimating and updating an offset for each map segment. This describes coordinate system transformation and a position change, while a vehicle is moving along a curved route. As an example, the vehicle may move along the curved route. The direction of the vehicle may rotate by Δθ. After the movement, a new position of the vehicle may be represented as ΔX and ΔY.

The road edge offset estimation device may calculate a position change (ΔX, ΔY) on a global coordinate system, using the amount of movement Δx′ and Δy′ and a rotation angle Δθ on a vehicle coordinate system. The road edge offset estimation device may perform transformation using a rotation matrix. An offset may be estimated by reflecting a lane map matching lateral correction value in road edge sensor data. In this case, the road edge offset estimation device may consider that a lane map matching result is identical to a real position because the lane map matching result is accurate.

Furthermore, the correction of the road edge sensor data may include fusing pieces of position data collected by a plurality of sensors via position fusion to generate more accurate and reliable position information and checking a source used in lateral correction in a module for estimating an optimal position based on the map matching result. This may include correction of a forward lane or a side lane. Furthermore, in an embodiment of the present disclosure, the road edge offset estimation device may perform time compensation for the amount of lateral correction of the checked resource at a road edge recognition time point.

Thus, the road edge offset estimation device may reflect the amount of correction calculated via the time compensation for the amount of lateral correction in road edge sensor data. When offset pollution of the amount of heading correction is weighted upon incorrect lane detection, the road edge offset estimation device may fail to apply the amount of heading correction. When not applying the amount of heading correction, the road edge offset estimation device may perform only translation distance correction.

This is to prevent a problem in which an error is accumulated when the translation distance is measured via pieces of data of the plurality of sensors. As described above, the road edge offset estimation device according to an embodiment of the present disclosure may correct an error in each of pieces of sensor data, may estimate an accurate translation distance on a global coordinate system, may minimize a difference between a real translation distance (or a translation vector ΔX and ΔY) and a translation distance (Δx′, Δy′) measured by the sensor, and may combine accurate rotation correction to perform precise localization. The road edge offset estimation device may perform correction based on sensor fusion and may selectively apply heading correction with regard to error accumulation. This may minimize an error in translation distance measurement and error accumulation to enable accurate localization.

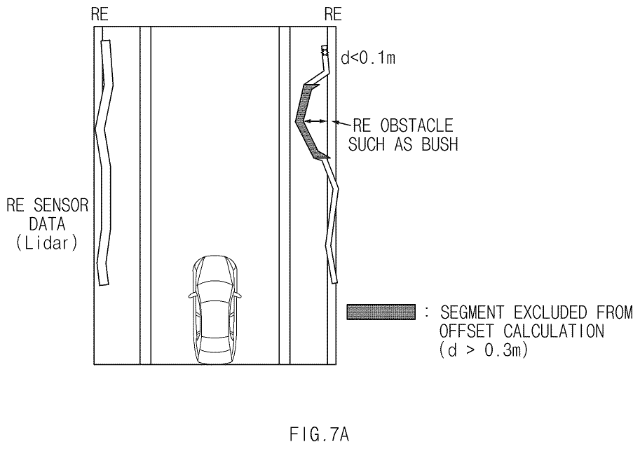

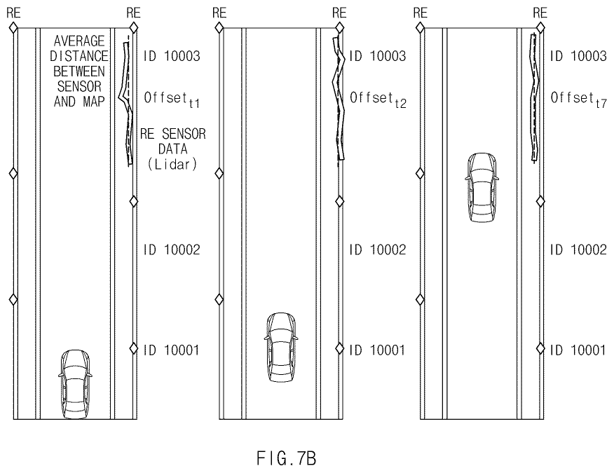

FIG. 7A is a drawing illustrating the concept of calculating an offset except for a portion of a map segment according to an embodiment of the present disclosure. FIG. 7B is a drawing illustrating the concept of calculating a relative offset for each time zone according to an embodiment of the present disclosure.

Referring to FIGS. 7A and 7B, a description is given of distance calculation with a map segment for each sensor segment and REoffset calculation of the map segment. REoffset (i.e., relative offset) indicates a relative position from a reference point on a map to a specific segment or point. This defines a relative position relationship of map data, which is used to correct a connection relationship or a relative position between segments and indicates how relatively far away the position of the vehicle is from a specific segment on an HD map. Thus, a road edge offset estimation device may fine the closest map segment meeting a height condition for each midpoint of a sensor segment and may calculate a distance away from the matched sensor segment.

Furthermore, the road edge offset estimation device may make a weighted average of a distance from the sensor, which are calculated for each map segment to calculate REoffset. REoffset may include calculating a weighted average for a segment length or may include a vertical distance (or a lateral distance) in a progress direction of a vehicle. Furthermore, only representative sensor segment data adopted by a data selection device may be used to calculate an offset. As an example, a map segment for a curb may fail to be calculated as an offset. This is to prevent a thicket around the curb from being usable as the result of misrecognition, which may include selectively using the curb for matching.

As an example, as shown in FIG. 7A, data in which a map/sensor distance is greater than or equal to 0.5 m may fail to be used to calculate a map offset. This may include determining and excluding abnormal data to perform offset calculation. Furthermore, a set threshold for the map/sensor distance may be variably set and applied for accurate localization. As an example, there is data in which the map/sensor distance is less than 0.1 m. Data in which the map/sensor distance is greater than 0.3 m may be determined as being abnormal and may fail to be calculated as offset calculation. FIG. 7B is calculating REoffset for each time zone, which may include calculating REoffset (or an error in relative position) which occurs on a movement route for each time zone, when an autonomous vehicle drives along a map segment.

The road edge offset estimation device may analyze a change in REoffset over time, may identify a pattern in which a position error is accumulated, and may perform correction with regard to it. Thus, the road edge offset estimation device may correct REoffset in a lane centerline in real time and may control lane keeping and lane change. As described above, the road edge offset estimation device according to an example of the present disclosure is able to apply relative position correction in the lane centerline via fusion of a camera, LiDAR, and an IMU sensor and may then perform precise localization.

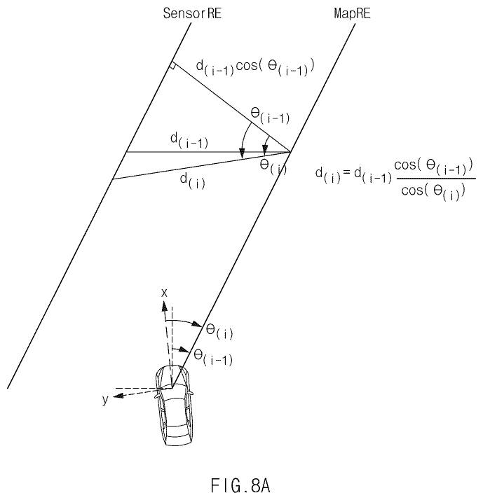

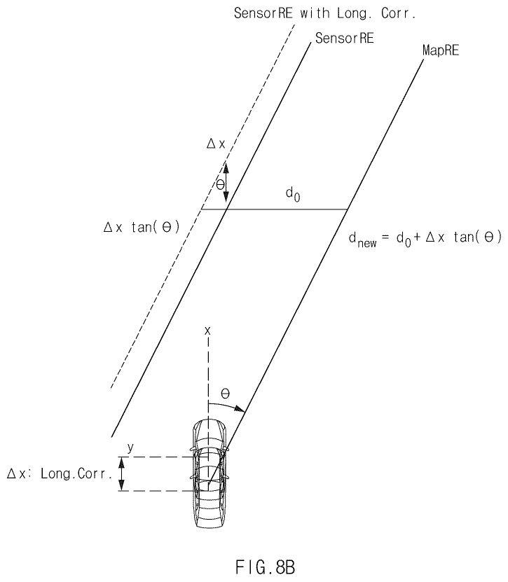

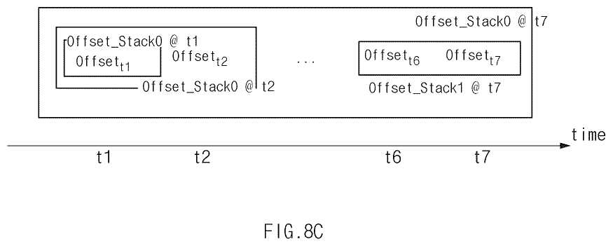

FIG. 8A is a drawing illustrating the concept of updating a relative offset stack according to a heading change according to an embodiment of the present disclosure. FIG. 8B is a drawing illustrating the concept of resetting a relative offset of a map according to an embodiment of the present disclosure. FIG. 8C illustrates an example of updating a relative offset stack and applying a moving average according to an embodiment of the present disclosure.

FIGS. 8A to 8C describe an REoffset stack update and error correction of a map segment according to a heading change. REoffset stack is data in which an REoffset (i.e., relative offset) value for the map segment is accumulated in a time sequence. Thus, a vehicle control apparatus may accumulate an error according to a heading change, an amount of vertical correction, and the like via the REoffset stack and may record/manage a change pattern of a relative position via the REoffset stack.

When the error is accumulated or an abnormal offset change is detected, the vehicle control apparatus may reset or delete the REoffset stack to maintain accurate localization. FIG. 8A illustrates updating an REoffset stack according to a heading change according to an embodiment of the present disclosure, which illustrates recalculating a vertical distance (or offset) from a map segment, when a heading change occurs. When the heading change is large or a change in segment angle is large, because an REoffset value is able to greatly vary, a possibility of error occurrence may be large. Thus, after recalculating the vertical distance (or an offset), the vehicle control apparatus may update an existing REoffset stack.

FIG. 8B illustrates resetting an REoffset of a corresponding map, when estimating an error in an REoffset of a specific map segment. When the amount of vertical correction is applied, a lateral error may occur. Particularly, because it is able to be greatly different from REoffset previously calculated according to the amount of vertical correction depending on an angle of a diagonal component, there may be a possibility of error occurrence. Thus, when it is expected to generate an error due to the vertical correction, the vehicle control apparatus may reset the offset.

As an example, when the lateral error due to the amount of vertical correction, which occurs in a current frame, is greater than 0.1 m (or when the lateral error is greater than 0.1 m), the vehicle control apparatus may delete an offset of a corresponding map (or an offset calculated at point B) and may reset the REoffset stack. Furthermore, when a lateral error accumulation value due to the amount of vertical correction is greater than 0.1 m, the vehicle control apparatus may delete the REoffset stack of the map. This measures for preventing an accumulated drift error. When a difference between a minimum offset value and a maximum offset value in the REoffset stack of a specific map segment is greater than 0.1 m, the vehicle control apparatus may delete the REoffset stack of the map. This may include detecting an abnormal increase in error or occurrence of an outlier and resetting the REoffset stack. Furthermore, when performing update management based on a time, as an example, when there is an REoffset of a map which is not updated for 10 seconds, the vehicle control apparatus may delete the REoffset stack of the map. This is to prevent old data from having an influence on an error as the old data is accumulated, which is to maintain continuity in real-time localization to ensure accuracy.

FIG. 8C illustrates an example of updating an REoffset stack and applying a moving average, which describes managing an REoffset stack based on a map segment ID and correcting an error using a moving average (MA). The REoffset stack has a data structure for accumulating and managing an REoffset (or a relative position error) for a map segment. Thus, the vehicle control apparatus may generate a separate stack for each map segment ID and may update an REoffset calculated per frame to a weighted average.

The vehicle control apparatus may store an REoffset value in a time sequence, which may apply a moving average to remove noise and calculate an averaged error correction value. When a continuous error fluctuation occurs in map matching and localization, the vehicle control apparatus may perform averaged position correction using the moving average. The moving average may maintain an REoffset value of a previous frame by a certain number (e.g., window size 10) and may perform averaging.

According to an example, the vehicle control apparatus may compare a map segment ID to find a stack, may calculate an REoffset of the stack using a weighted average for a sensor length, and may calculate an offset of an original stack of a specific map segment ID and an offset of a current frame. The vehicle control apparatus may manage two REoffset stacks like REoffset 0 and REoffset 1 and may store a result in which the window size is maximum 10. This is the same as Table 1 below.

TABLE 1

| Time | t1 | t2 | t3 | t4 | t5 | t6 |
|---|---|---|---|---|---|---|
| Stack0 | 1 | 1, 2 | 1, 2, 3 | 1, 2, . . . , 4 | 1, 2, . . . , 5 | 1, 2, . . . , 6 |
| Stack1 | N/A | N/A | N/A | N/A | N/A | 6 |
| Final | Stack0 | Stack0 | Stack0 | Stack0 | Stack0 | Stack0 |
| offset | | | | | | |
| output | | | | | | |
| stack | | | | | | |
| Window | 1 | 2 | 3 | 4 | 5 | 6 |
| size | | | | | | |

| Time | t7 | t8 | t9 | t10 | t11 | t12 |
|---|---|---|---|---|---|---|
| Stack 0 | 1, 2, . . . , 7 | 1, 2, . . . , 8 | 1, 2, . . . , 9 | 1, 2, . . . , 10 | 11 | 11, 12 |
| Stack 1 | 6, 7 | 6, 7, 8 | 6, 7, . . . , 9 | 6, 7, . . . , 10 | 6, 7, . . . , 11 | 6, 7, . . . , 12 |
| Final | Stack0 | Stack0 | Stack0 | Stack0 | Stack1 | Stack1 |
| offset | | | | | | |
| output | | | | | | |
| stack | | | | | | |
| Window | 7 | 8 | 9 | 10 | 6 | 7 |
| size | | | | | | |

| Time | t13 | t14 | t15 | t16 |
|---|---|---|---|---|
| Stack 0 | 11, 12, 13 | 11, 12, . . . , 14 | 11, 12, . . . , 15 | 11, 12, . . . , 16 |
| Stack 1 | 6, 7, . . . , 13 | 6, 7, . . . , 14 | 6, 7, . . . , 15 | 16 |
| Final | Stack1 | Stack1 | Stack1 | Stack1 |
| offset | | | | |
| output | | | | |
| stack | | | | |
| Window | 8 | 9 | 10 | 6 |
| size | | | | |

window size: number of frames used to calculate final output stack

As described above, Table 1 is to minimize memory usage using two stacks and apply an efficient moving average. Stack 1 stores frame data from t1 to t5 and stack 2 stores frame data from t6 to t10. In other words, frame data is not stored in stack 1 up to t5 (=10/2), frame data is stored in stack 1 from t6, and frame data is stored in stack 2 from t7. A final moving average is calculated based on a value stored in stack 2 at t10.

Because stack 1 and stack 2 are alternately used to calculate a moving average, it is possible to output a continuous average value. When three stacks (e.g., stack 1, stack 2, and stack 3) are used, frame data is stored in stack 1 from t4, frame data is stored in stack 2 from t7, and frame data is stored in stack 3 from t10. An average value of stack 3 is finally output. As the window size is about 8-10, the accuracy of the moving average is improved. For a newly recognized map segment, the vehicle control apparatus may generate a new stack corresponding to a corresponding map segment ID, may add an initial REoffset value to the stack, and may then update the initial REoffset value to a weighted average. To maintain connectivity with an existing stack, the vehicle control apparatus may set a weight to be low to gradually perform averaging.

The vehicle control apparatus for estimating an offset and performing road edge map matching according to an embodiment of the present disclosure may calculate an offset with a lateral distance of a road edge map with regard to sensor data obtained via a plurality of sensors, in estimating an offset of the road edge map. The vehicle control apparatus may determine whether there is abnormal data such that the offset is not polluted due to the abnormal data in which an error occurs. Furthermore, the vehicle control apparatus may calculate an offset using a moving average such that a sensor error in long range/short range is not reflected in the offset to perform calculation, even without storing all pieces of data corresponding to a window size, thus reducing a memory.

Furthermore, when a new value is input, the vehicle control apparatus may perform calculation using two stacks, thus updating an average at faster and less complexity. Furthermore, the vehicle control apparatus may differently set a short/long range data weight and may support an advantage of reducing a sensor error. Thus, the vehicle control apparatus may apply a previously calculated offset to maintain road edge map matching performance, when a map segment is present in a long range, thus providing the advantage of ensuring the reliability of localization. The vehicle control apparatus may assist in efficiently calculating a real-time moving average, while minimizing the offset of the sensor data, and may support safety of vehicle driving upon autonomous driving.

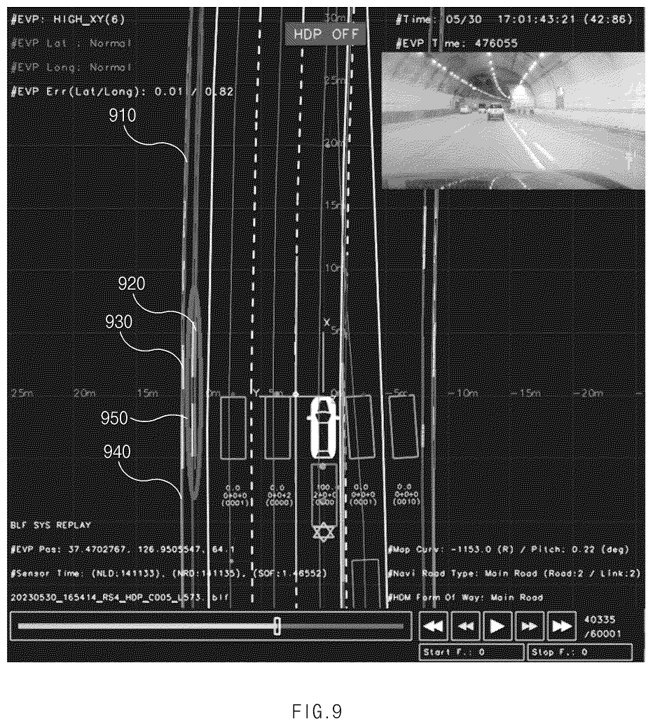

FIG. 9 is a drawing illustrating an example of applying a road edge offset to implement a map according to an embodiment of the present disclosure.

Referring to FIG. 9, a first line 910 indicates recognized sensor data and a second line 920 indicates sensor data (or raw data) used for matching. A third line 930 indicates usage sensor data to which an offset is applied and a fourth line 940 indicates a map road edge. As shown in FIG. 9, it may be seen that a map construction surface for a left road edge (fifth line) 950 and sensor recognition are different from each other, but road edge map matching performance is ensured via offset estimation.

A map matching device including an offset estimation device according to an embodiment of the present disclosure may estimate an offset of a map based on the result of sensor recognition and ensure road edge map matching positioning performance using it. As described above, positioning is an essential element to operate an autonomous vehicle, and a plurality of autonomous driving perform autonomous driving based on an HD map. In addition, when an HD road edge is a road edge which changes in shape depending on a height, considering constructing a shape in 2D depending on one line for a specific height and storing the shape together with a construction height, road edge map matching performance may deteriorate as a lateral offset is present because the same height as the map is not recognized.

When a lateral/heading error occurs because an accurate position is not estimated and when a route is generated and vehicle control is performed based on the incorrect position, this may cause fatal operation or threaten a vehicle and a user. Thus, an embodiment of the present disclosure for estimating an offset of a map based on the result of sensor recognition and performing road edge map matching positioning using it may include recognizing long range information via a LiDAR sensor and estimating an offset of a map segment using the information. Road edge map matching is characterized by applying an offset previously calculated when the map segment is present in a long range to ensure road edge map matching performance, using pieces of relatively close data.

In ensuring offset estimation performance, the vehicle control apparatus may determine a situation in which an incorrect offset is calculated and may selectively perform a reset. Thus, the vehicle control apparatus for performing map matching according to an embodiment of the present disclosure may continuously ensure positioning performance and may selectively estimate and reflect an offset, even when driving on a road edge, a shape of which changes according to a height, thus ensuring vehicle control performance and supporting stable operation of an autonomous driving system.

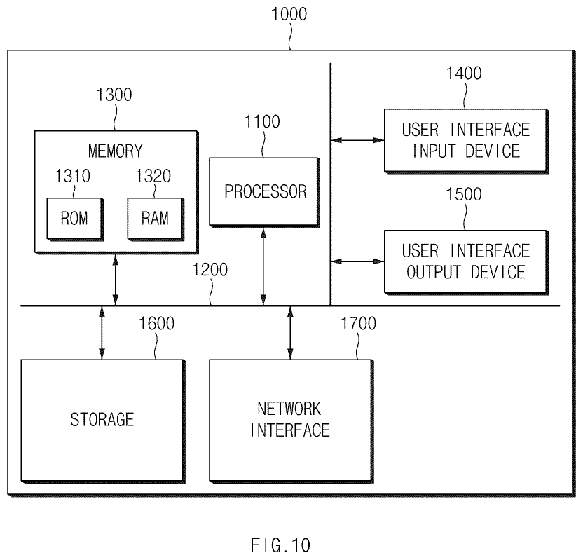

FIG. 10 illustrates a computing system according to an embodiment of the present disclosure.

Referring to FIG. 10, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may estimate an offset to estimate position information via comparison with a high-definition map with regard to sensor data with high reliability and accuracy among pieces of sensor data checked from a plurality of sensors, thus receiving a map which is safer and has ensured reliability.

Furthermore, the present technology may manage and estimate an offset between the sensor and the map for each segment of the high-definition map in the form of a list and a stack for each object and ensure the efficiency of a computation process and a speed for real-time localization and computation efficiency using an average offset. As a result, the present technology may ensure reliability of road edge map matching performance.

In addition, various effects ascertained directly or indirectly through the present disclosure may be provided.

Hereinabove, although the present disclosure has been described with reference to embodiments and the accompanying drawings, the present disclosure is not limited thereto, but may be variously modified and altered by one having ordinary skill in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed based on the accompanying claims, and all the technical ideas within the scope equivalent to the claims should be included in the scope of the present disclosure.

What is claimed is:

1. A vehicle control apparatus, comprising:
a first processor configured to generate valid sensor data based on raw data collected from at least one sensor;
a management device configured to load and manage high-definition (HD) map data; and
a second processor configured to:
filter data for map matching from the valid sensor data;
select data whose reliability satisfies a predefined threshold from the filtered valid sensor data;
determine an offset by comparing the selected data with the HD map data;
correct the selected data based on the determined offset;
determine a position of a vehicle by matching the corrected data with the HD map data; and
control the vehicle based on the determined position of the vehicle.

2. The vehicle control apparatus of claim 1, wherein the second processor includes a map matching module,
wherein the map matching module is configured to:
manage the offset in the form of a list or a stack including identification information about each object,
wherein the offset is calculated by applying a moving average, and
wherein the identification information is assigned to each object in response to a map segment of an HD map.

3. The vehicle control apparatus of claim 2, wherein the map matching module includes:
a data filtering device configured to:
selectively filter line or point data associated with a road edge from the valid sensor data; and
store and manage the filtered data.

4. The vehicle control apparatus of claim 3, wherein the data filtering device is further configured to:
remove sensor data which does not meet a condition of at least one of a distance, an angle, or a height from the valid sensor data.

5. The vehicle control apparatus of claim 2, wherein the map matching module further includes:
a data selection device configured to extract data optimal for matching from the valid sensor data.

6. The vehicle control apparatus of claim 5, wherein the data selection device is further configured to:
extract data for one segment or layer of each object from the selected data.

7. The vehicle control apparatus of claim 2, wherein the map matching module further includes:
an offset estimation device configured to check an offset generated on road edge coordinates between the selected data and the HD map data.

8. The vehicle control apparatus of claim 7, wherein the offset estimation device is further configured to:
estimate an offset for each map segment; and
calculate the offset by checking a map segment closest to a sensor segment.

9. The vehicle control apparatus of claim 8, wherein the offset estimation device is further configured to:
calculate an average value for the offset of the sensor segment for each map segment; and
store the calculated average value.

10. The vehicle control apparatus of claim 8, wherein the offset estimation device is further configured to:
perform correction by applying an amount of lateral correction of a lane to road edge sensor recognition data.

11. The vehicle control apparatus of claim 2, wherein the map matching module further includes:
an offset estimation device configured to store the offset for each identification information in response to the map segment of the HD map, store the offset based on a current position, update the offset based on a current frame, or delete invalid data.

12. The vehicle control apparatus of claim 2, wherein the map matching module further includes:
a map matching device configured to apply a matching algorithm to the data of the sensor and the HD map data to calculate an amount of position correction, and
wherein the map matching device is configured to:
estimate a position and a pose by applying an algorithm for matching two points.

13. The vehicle control apparatus of claim 12, wherein the map matching device is further configured to:
calculate an amount of correction for a lateral position and a heading position for the selected data; and
calculate and output a position of the vehicle in an absolute coordinate system to which the amount of correction is applied.

14. The vehicle control apparatus of claim 2, wherein the map matching module is further configured to:
calculate a position change, using information about translation on a coordinate system of the vehicle and information of a rotation angle, wherein the offset includes a lateral correction value including at least one of a forward lane or a side lane; and
generate road edge sensor data by applying time compensation to the lateral correction.

15. The vehicle control apparatus of claim 14, wherein the map matching module is further configured to:
apply rotation correction such that the offset becomes minimum by comparing a translation distance of the vehicle, the translation distance being checked via a global coordinate system, with a translation distance checked via the sensor.

16. The vehicle control apparatus of claim 14, wherein the map matching module is further configured to:
calculate a distance with the map segment for each sensor segment;
calculate an average offset based on a relative offset for each map segment; and
estimate a lateral position and a heading position of the vehicle based on the calculated average offset.

17. The vehicle control apparatus of claim 1, wherein the first processor is further configured to:
generate the raw data as the data for the map matching by checking the raw data and removing or correcting noise.

18. The vehicle control apparatus of claim 1, wherein the management device is further configured to:
parse an HD map including road edge information; and
extract edge information of a top line or a bottom line of a road as two-dimensional segment information from the parsed HD map, and
wherein the road edge information includes road geometry information or road facility information.

19. The vehicle control apparatus of claim 1, wherein the at least one sensor includes light and detection ranging (LiDAR) sensor,
wherein the second processor is further configured to:
check contour data of each object recognized using the LiDAR sensor;
check a size, a shape, a position of each object using the contour data; and
maintain and manage data of each object by classifying the contour data as a layer number, and
wherein the contour data includes points cloud data indicating a contour of the object.

20. A vehicle control method, comprising:
generating valid sensor data based on raw data;
loading and managing high-definition (HD) map data;
filtering data for map matching from the valid sensor data;
selecting data whose reliability satisfies a predefined threshold from the filtered data;
determining an offset by comparing the selected data with the HD map data;
correcting the selected data based on the determined offset;
determining a position vehicle by matching the corrected data with the HD map data; and
controlling the vehicle based on the determined the position of the vehicle,
wherein the matching includes:
comparing a translation distance of the vehicle, the translation distance determined in a global coordinate system, with a translation distance of the selected data; and
applying rotation correction based on the comparison to minimize the offset, thereby performing matching, and
wherein the offset is calculated by applying a moving average and is managed in the form of a list or a stack including identification information about each object.
